(19) United States
(12) Patent Application Publication
(10) Pub. No.: US 2026/0131447 A1
(43) Pub. Date: May 14, 2026

(54) HAND TOOL AND METHOD OF CONSTRUCTION

(71) Applicant: LEVEL 5 TOOLS, LLC, Kansas City, KS (US)

(72) Inventors: Scott A. Murray, Lenexa, KS (US); Travis L. Marting, Powell, OH (US); Timothy A. Horn, Columbus, OH (US); Wen Zhang, Kunshan City (CN)

(21) Appl. No.: 19/389,818

(22) Filed: Nov. 14, 2025

Related U.S. Application Data
(60) Provisional application No. 63/720,493, filed on Nov. 14, 2024.

(51) Int. Cl. B25G 3/34; E04F 21/165

(52) U.S. Cl. CPC B25G 3/34; E04F 21/1657

(57) ABSTRACT

A metal hand tool includes a handle attached to a blade piece and method of construction. The handle is made up of two, welded, symmetrical handle halves, each handle half having an opening for receiving a hang hole piece and a notched distal end. The distal end of the handle includes a channel configured to receive a backer plate or an insert clamp welded to a proximal end of the blade piece. The backer plate or insert clamp are welded along an edge of the channel to create a seamless one-piece tool handle tool. The hand tool further includes a hang hole piece configured for placement through the hang hole openings in the handle and for welded connection to the handle.

### RELATED APPLICATIONS

This application claims the benefit of U.S. Provisional Application No. 63/720,493 filed Nov. 14, 2024.

### FIELD OF THE INVENTION

The present application relates generally to hand tools and, more specifically, to durable, drywall finishing hand tools and methods of construction.

### BACKGROUND

Hand tools, such as putty knives, also known as joint knives, and taping knives, are commonly used in drywall finishing to spread putty or joint compound and/or to scrape walls and surfaces during installation of drywall, also known as gypsum board. These tools are also commonly used to scrape various surfaces, including but not limited to removal of textured ceiling or wall surfaces, removal of wallpaper, and removal of adhesives. Such putty knives and taping knives each include a handle opposite a metal blade, which blade is preferably flexible to accommodate efficient scraping and spreading techniques. Additionally, other industries, including but not limited to the food industry, utilize similar hand tools, such as scrapers or spatulas, to scrape surfaces, cut various objects, and/or flip various objects.

Many currently available putty knives, taping knives, scrapers, and spatulas include plastic or rubber handles. However, some users find such plastic or rubber handles to be uncomfortable to hold or to use. Additionally, some users find these plastic or rubber handles to be too weak and/or susceptible to breaking after repeated application of force on the blade. Furthermore, some industries and locations, including but not limited to the food industry and medical facilities, require sterile environments, and plastic or rubber handles can allow for contamination to occur and/or unwanted microorganisms to grow. Accordingly, a comfortable, durable, sterilizable hand tool is desired.

While some companies offer putty knives and/or taping knives which are fully made of metal, such available metal hand tools are weaker than many users desire. These tools are weaker than desired because they generally have one insufficient point of connection between the blade and the handle, generally rivets (or other mechanical fasteners) or a small weld at the base of the handle to the blade. Wear and tear from repeated application of force to these tools can make them prone to breaking.

### SUMMARY OF THE INVENTION

The present application discloses a strong, durable, all metal hand tool and method of construction. In a preferred embodiment, the hand tool is comprised completely of stainless steel, or an alternative sterilizable metal, and includes a blade piece connected to a handle. In an aspect of the present application,

In an exemplary embodiment, a metal hand tool may comprise a blade piece having proximal end and a distal end opposite the proximal end, the blade piece distal end comprising a blade, a backer plate configured to attach to and encompass the proximal end of the blade, and a handle having a proximal end and a distal end opposite the proximal end and a hollow interior. The handle may have a channel in the distal end. The channel may be configured to receive the backer plate. The backer plate may be welded to the blade piece at the proximal end, and the backer plate may be received within and welded to the channel.

In one aspect of the metal hand tool, the handle may be formed from a pair of symmetrical handle half pieces that are welded together.

In another aspect of the metal hand tool, the hand tool may further comprise an insert clamp configured to receive and attach to the backer plate, wherein the channel is further configured to receive the insert clamp.

In another aspect of the metal hand tool, the insert clamp may be welded to the handle along the entire edge of the channel and welded to the backer plate.

In another aspect of the metal hand tool, a shape of the insert clamp may be substantially the same as a profile of the edge of the channel.

In another aspect of the metal hand tool, the handle may further comprise an opening extending through the proximal end of the handle.

In another aspect of the metal hand tool, the metal hand tool may further comprise an open hang hole piece extending through the opening at the proximal end of the handle, the open hang hole piece welded to said handle around outer edges of said hang hole piece.

In another aspect of the metal hand tool, the hand tool may be completely made of stainless steel.

In another aspect of the metal hand tool, the proximal end of the handle may comprise a flattened hammer end.

In another aspect of the metal hand tool, the blade piece may be flexible for accommodating spreading, scraping, or flipping materials and the blade piece may be configured to flex under an applied pressure.

In another aspect of the metal hand tool, the distal end of the handle may be curved such that the edge of the channel is curved and the resulting welded connection between the channel and the backer plate is curved.

In another aspect of the metal hand tool, the distal end of the handle may be curved concavely away from the proximal end of the handle.

In another aspect of the metal hand tool, the distal end of the handle may be curved convexly toward the proximal end of the handle.

In another exemplary embodiment, a metal hand tool may comprise a blade piece having proximal end and a distal end opposite the proximal end, the blade piece distal end comprising a blade, a backer plate configured to attach to and encompass the proximal end of the blade, an insert clamp configured to receive and attach to the backer plate, and a handle having a proximal end and a distal end opposite the proximal end and a hollow interior. The handle may have a channel in the distal end; the channel being configured to receive the insert clamp. The backer plate may be welded to the blade piece at the proximal end, the backer plate may be welded to the insert clamp, and the insert clamp may be welded to the handle along an entire edge of the channel.

In one aspect of the metal hand tool, the handle may be formed from a pair of symmetrical handle half pieces that may be welded together.

In another aspect of the metal hand tool, a shape of the insert clamp may be substantially the same as a profile of the edge of the channel.

In another aspect of the metal hand tool, the hand tool may be completely made of stainless steel.

In another aspect of the metal hand tool, the distal end of the handle may be curved such that the edge of the channel is curved and the resulting welded connection between the channel and the insert clamp is curved.

In another aspect of the metal hand tool, the interior hollow interior of the handle may be sealed from an exterior of the handle.

In yet an exemplary embodiment, a metal hand tool may comprise a blade piece having proximal end and a distal end opposite the proximal end, the blade piece distal end comprising a blade, a backer plate configured to attach to and encompass the proximal end of the blade, an insert clamp configured to receive and attach to the backer plate, a handle having a proximal end and a distal end opposite the proximal end and a hollow interior, the handle having a channel in the distal end and an opening extending through the proximal end of the handle, the channel being configured to receive the insert clamp, and an open hang hole piece extending through the opening at the proximal end of the handle. The backer plate may be welded to the blade piece at the proximal end, the backer plate may be welded to the insert clamp, the insert clamp may be welded to the handle along an entire edge of the channel the open hang hole piece welded to said handle around outer edges of said hang hole piece. The interior hollow interior of the handle may be sealed from an exterior of the handle.

When fully assembled, the hand tool of the present application provides a strong, durable, and sterilizable hand tool.

### BRIEF DESCRIPTION OF THE DRAWINGS

The drawings constitute a part of this specification and include exemplary embodiments illustrating various objects and features thereof.

FIG. 1 is an upper, distal end, perspective view of a hand tool.

FIG. 2 is a top, elevational view of the hand tool, the bottom, elevational view being a mirror image thereof.

FIG. 3 is a distal end, elevational view of the hand tool.

FIG. 4 is a proximal end, elevational view of the hand tool.

FIG. 5 is a right side, elevational view of the hand tool, the left side, elevational view being a mirror image thereof.

FIG. 6 is an upper, distal end, perspective, exploded view of the handle of the hand tool.

FIG. 7 is an upper, distal end, perspective, partially exploded view of the handle of the hand tool with a guide piece assembled into one handle half.

FIG. 8 is an upper, distal end, perspective, partially exploded view of the hand tool with an assembled handle and an exploded blade piece.

FIG. 9 is an upper, distal end, perspective view of the hand tool with the blade piece assembled into the handle, including a broken portion of the handle piece to illustrate the connection between the blade piece extended tang and the handle.

FIG. 10 is an upper, distal end, perspective, partially exploded view of the hand tool with an assembled handle and blade piece and an exploded hang hole piece.

FIG. 11 is a side, elevational, cross-sectional view of the hand tool.

FIG. 12 is an upper, distal end, perspective, exploded view of a hand tool including alternative guide pieces connected to the inside of the handle, one alternative guide piece in each handle half.

FIG. 13 is a side, elevational, cross-sectional view of the hand tool having alternative guide pieces.

FIG. 14 is an upper, distal end, perspective view of an alternative embodiment of a hand tool, showing the blade piece elongated tang in dashed lines.

FIG. 15 is a top, elevational view of the alternative embodiment of a hand tool, the bottom, elevational view being a mirror image thereof.

FIG. 16 is an upper, distal end, perspective, exploded view of the alternative embodiment of the hand tool.

FIG. 17 is a front perspective view of a second alternative embodiment of the hand tool.

FIG. 18 is a front view of the second alternative embodiment of the hand tool.

FIG. 19 is a top view of the second alternative embodiment of the hand tool.

FIG. 20 is a bottom view of the second alternative embodiment of the hand tool.

FIG. 21 is a left-side view of the second alternative embodiment of the hand tool.

FIG. 22 is a right-side view of the second alternative embodiment of the hand tool.

FIG. 23 is a front perspective, exploded view of the second alternative embodiment of the hand tool.

FIG. 24 is a front perspective, exploded view of the second alternative embodiment of the hand tool illustrating potential weld locations.

FIG. 25 is a perspective view of the channel of the handle of the second alternative embodiment of the hand tool.

### DETAILED DESCRIPTION

As required, detailed aspects of the present application are disclosed herein, however, it is to be understood that the disclosed aspects are merely exemplary, which may be embodied in various forms. Therefore, specific structural and functional details disclosed herein are not to be interpreted as limiting, but merely as a basis for the claims and as a representative basis for teaching one skilled in the art how to variously employ the present application in virtually any appropriately detailed structure.

Certain terminology will be used in the following description for convenience in reference only and will not be limiting. For example, up, down, front, back, right, and left refer to the hand tool as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. The terms proximal and distal, when describing a hand tool, are intended to refer to the proximity to the trunk of a user's body when the hand tool is in use as intended. Said terminology will include the words specifically mentioned, derivatives thereof and words of similar meaning.

The present application discloses a strong, durable, all metal hand tool 2 configured for use scraping, spreading, cutting, and/or flipping material and a method of construction. The hand tool 2 of the present application includes a blade piece 6 connected to a handle 4 made up of two symmetrical, handle half pieces 8. In a preferred embodiment, the hand tool 2 is composed completely of stainless steel. However, alternatively, the hand tools may be made up of other metals. Preferably, the hand tool metal is sterilizable to accommodate use of the hand tool in sterile environments.

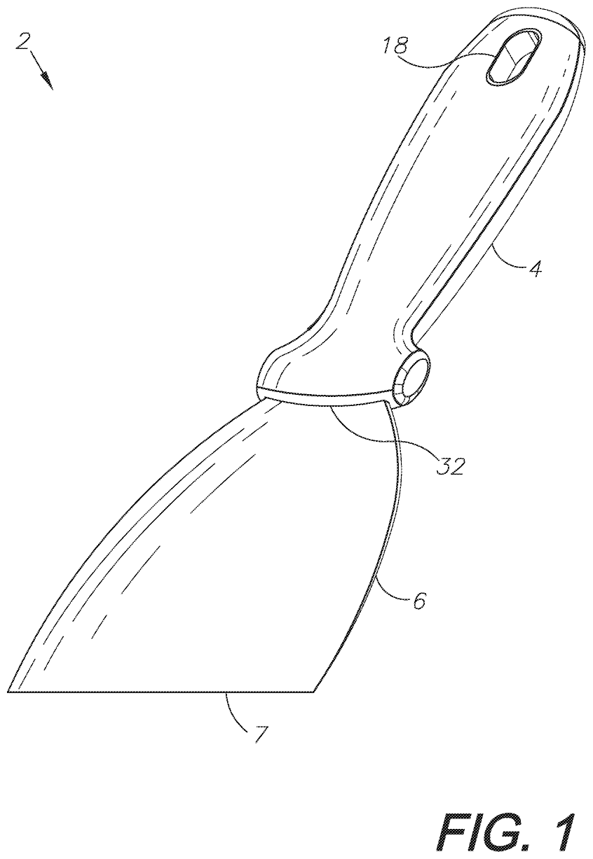

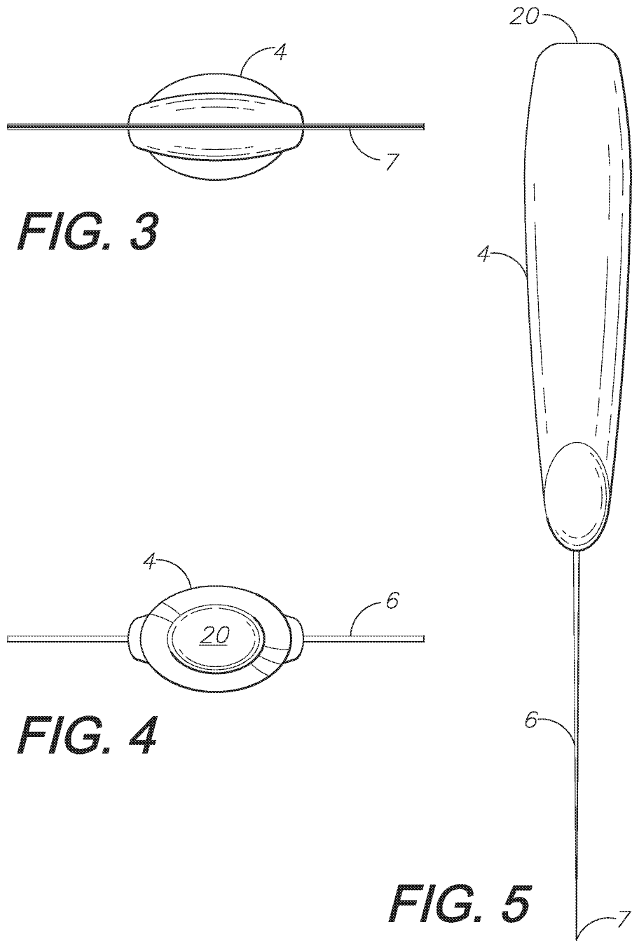

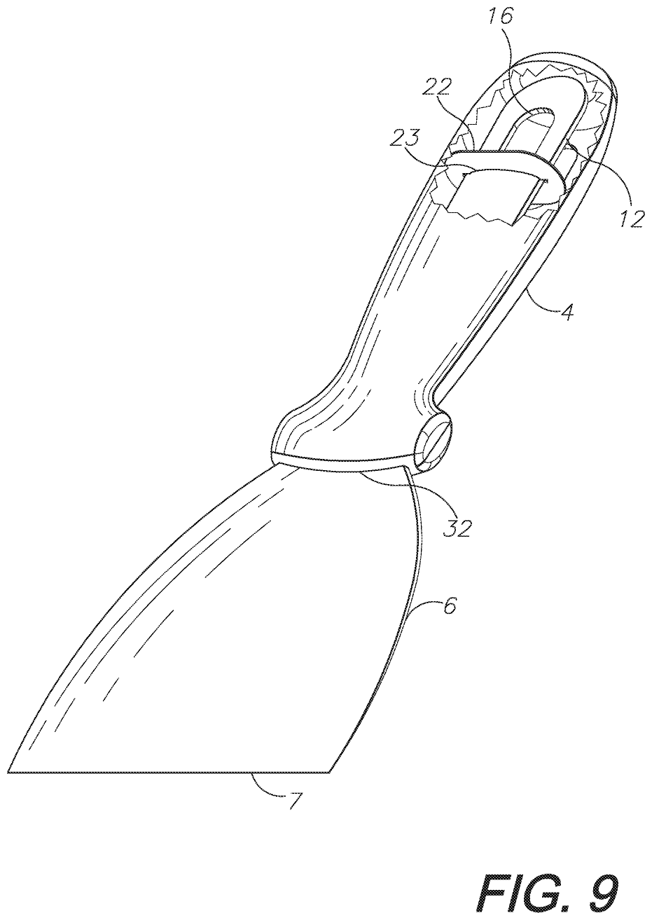

FIGS. 1-11 show an exemplary embodiment of a hand tool 2 of the present application. The hand tool 2, in this embodiment, has a blade piece 6 which includes a blade 7 configured for use in making contact with material to be scraped, spread, cut, or flipped. The blade piece 6 attaches to a handle 4, which is positioned opposite, or proximally, of the blade 7. The handle 4 is configured to be held by a user while the user applies force with the blade 7. Preferably, the blade 7 is flexible, in addition to being strong and durable, to accommodate efficient spreading, scraping, and/or flipping techniques. The shape, width, and thickness of the blade piece 6 can be varied in different embodiments. In some embodiments, the distal end of the blade 7 may be sharpened for cutting uses, while in other embodiments, the blade 7 distal end may be dull to prevent injury to the user or damage to other objects while still being effective for spreading, scraping, and/or flipping uses.

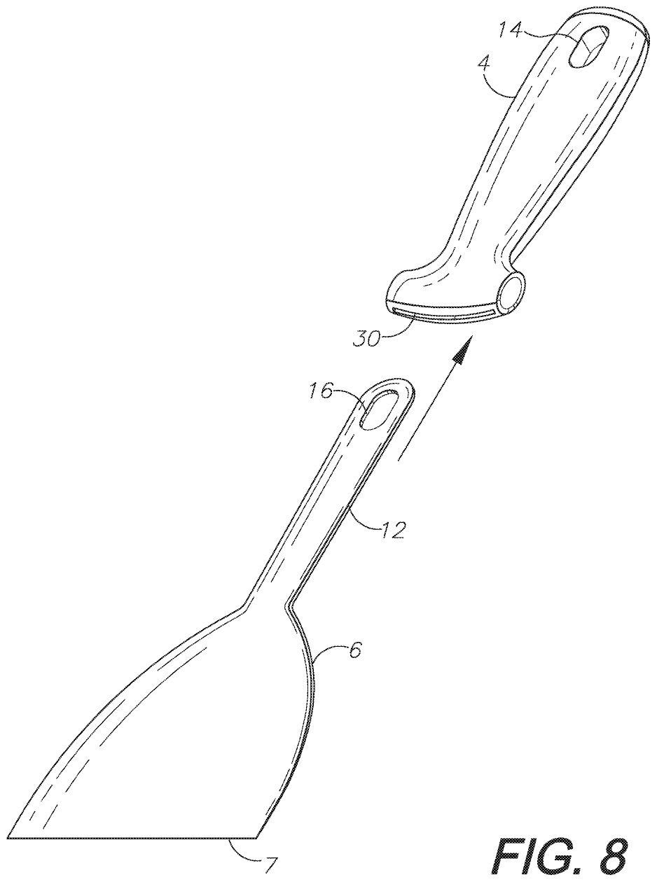

The blade piece 6 is substantially flat and includes an elongated tang 12 opposite or proximal to the blade 7. The elongated tang is 12 configured for placement within the handle 4 of the hand tool 2. In this embodiment, the blade piece elongated tang 12 is configured to extend the majority of the length of the handle 4 when the hand tool 2 is fully assembled, as shown in FIGS. 8-9 and 11. The blade piece tang 12 further includes an opening 16 near its proximal end for receiving a hang hole 18 therethrough.

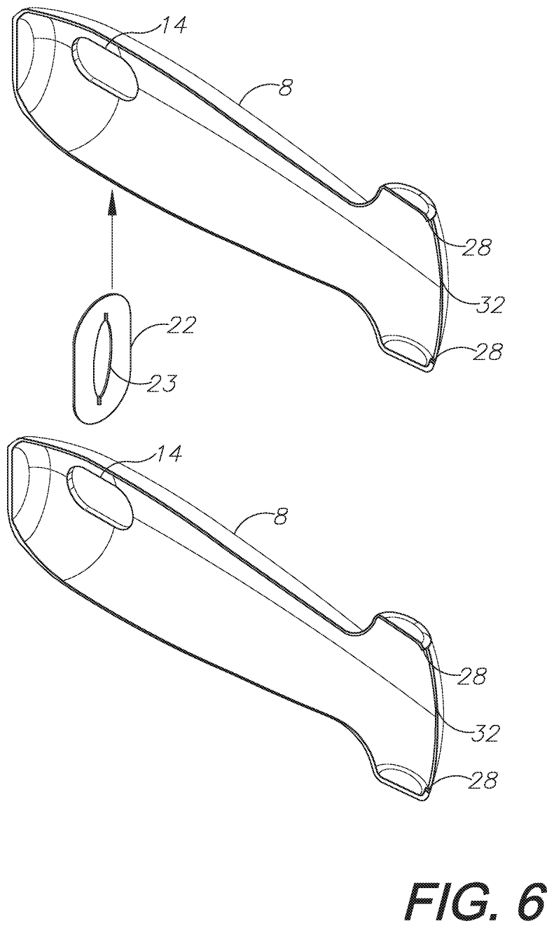

The handle 4, in this embodiment, is composed of two symmetrical, stainless steel, contoured handle halves 8, each handle half 8 having an opening 14 near the handle 4 proximal end configured for receiving a hang hole piece 18. Preferably, when assembled, the contour of the handle 4 provides a comfortable, ergonomic fit for a user's hand. In an exemplary embodiment, as shown in FIGS. 6-7, 9, and 11, the handle halves 8 each have a hollow interior. However, in alternative embodiments, the handle 4 can be made of solid metal, with a recessed groove or channel for connection to the blade piece 6 and an opening 14 for receiving a hang hole piece 18.

Each handle half piece 8 includes a slight notch 28 at its distal end such that when the handle halves 8 are aligned and welded together to form the assembled handle 4, an opening 30 is formed at the handle 4 distal end configured for receiving and closely fitting around the blade piece elongated tang 12, as shown in FIGS. 6-8. Additionally, in an exemplary embodiment, the handle 4 includes a curved distal end 32. Preferably, the curvature of the handle curved distal end 32 is concave toward the rest of the handle 4 and convex toward the blade 7 of the assembled hand tool 2, as shown in FIGS. 1-11. However, in alternative embodiments, the curvature of the handle distal end may curve in the opposite direction, or convex toward the rest of the handle and concave toward the blade. With the blade piece 6 assembled into the handle 4, the blade piece 6 and the handle 4 are welded to each other along the handle curved distal end 32 on either side of the blade piece 6. This curved weld provides added strength and durability to the hand tool 2. The curvature provides for additional surface area for the welded connection between the blade piece 6 and the handle 4. Moreover, the curved weld helps to better displace the force applied to the blade 7 when compared to a connection made in one linear plane.

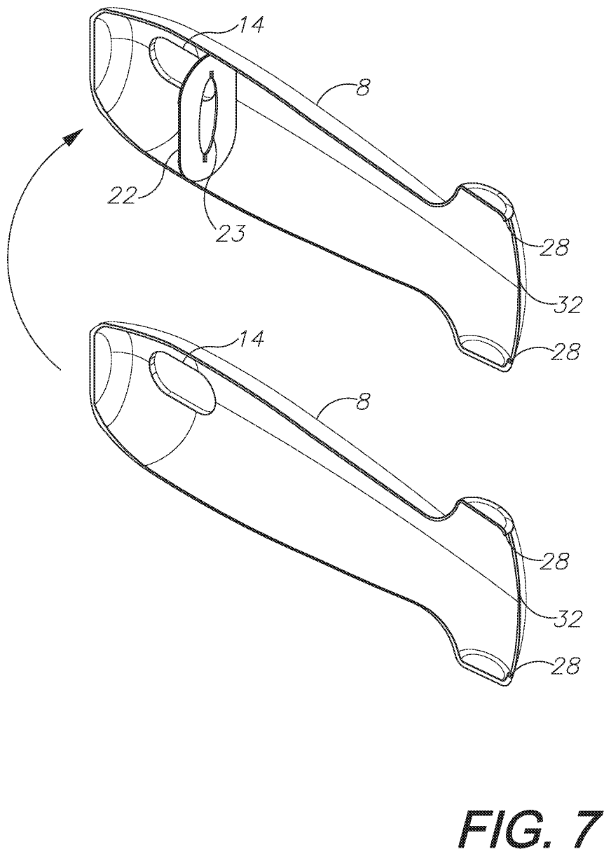

In the embodiment shown in FIGS. 1-11, one handle half 8 further includes an additional stainless steel tang guide piece 22 welded to the inside of the handle half 8 at a longitudinal position closer to the proximal end of the handle 4 than the distal end but distal of the hang hole opening 14. In a preferred embodiment, shown in FIGS. 6-7, the additional steel tang guide piece 22 is a stadium-shaped, or obround, piece of stainless steel and extends substantially across the entire width of the handle half 8. However, alternative shapes of a tang guide piece can be utilized in hand tools. In this embodiment, the additional steel tang guide piece 22 extends outward from the interior of the handle half 8 such that approximately half of the tang guide piece 22 fits within the handle half 8 to which it is welded, and the other approximate half of the tang guide piece 22 fits within the second handle half 8 when the handle halves 8 are assembled to form the handle 4.

The additional steel tang guide piece 22 includes an opening or receiver 23 configured for receiving the elongated tang 12 of the blade piece 6 when the blade piece 6 is inserted into the handle 4. In a preferred embodiment, the tang opening or receiver 23 in the additional stainless steel tang guide piece 22 is generally lens-shaped with extended ends configured for receiving and fitting tightly around the blade piece tang 12 to provide an additional point of strength between the blade piece 6 and the handle 4. The general lens-shape helps to more easily guide the elongated tang 12 into the tang opening or receiver 23 during assembly of the hand tool 2. However, a narrower tang guide piece opening or receiver for fitting more closely around the entire width of the blade piece tang 12 can also be used. Other embodiments may alternatively include a wider tang guide piece opening or receiver.

In an exemplary embodiment, to attach the additional stainless steel tang guide piece 22 to a handle half 8, a rivet or alternative small metal shaft is first spot welded to the handle half 8 intended to receive the additional steel tang guide piece 22. Then the tang guide piece 22 is welded to the rivet or alternative extended metal shaft using a shielded metal arc welding, or stick welding, technique. However, in other embodiments, the additional steel tang guide piece 22 may be precision welded to the interior of the handle half 8 or attached to the handle half 8 using alternative techniques.

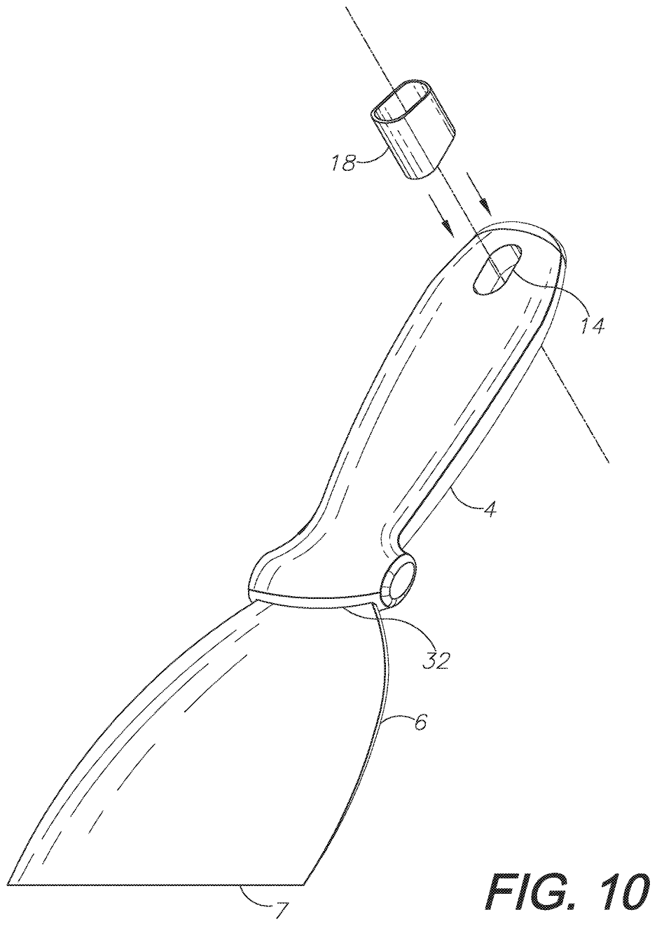

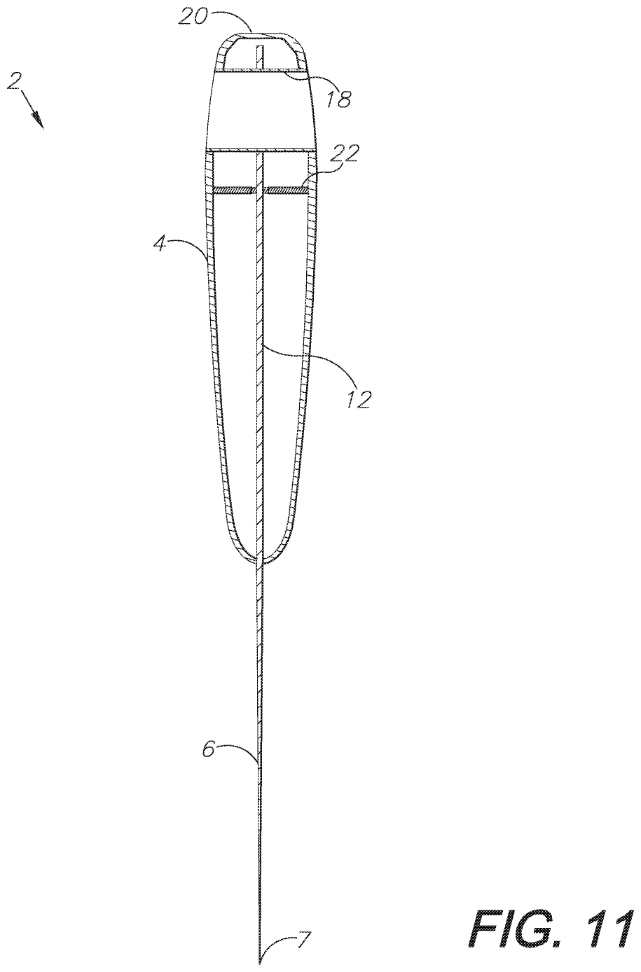

In this embodiment, a stainless steel hang hole piece 18 closely fits through the hang hole opening 14 in each handle half 8 and the hang hole opening 16 in the blade piece tang 12 with the tool 2 fully assembled, as shown in FIGS. 10-11. The hang hole 18 is welded to the handle 4 around each handle half hang hole opening 14, and the hang hole piece 18 connecting though the blade piece elongated tang 12 provides another point of strength for the connection of the blade piece 6 and the handle 4. The hang hole 18 of the hand tool 2 allows a user to hang the hand tool 2 on a hook or other object as desired. In the embodiment shown in FIGS. 1-11, the sides of the hang hole 18 form an obround or stadium shaped. However, alternatively, the hang hole can be circular, oval-shaped, diamond-shaped, square, rectangular, triangular, or any other shape. Further embodiments may not include a hang hole.

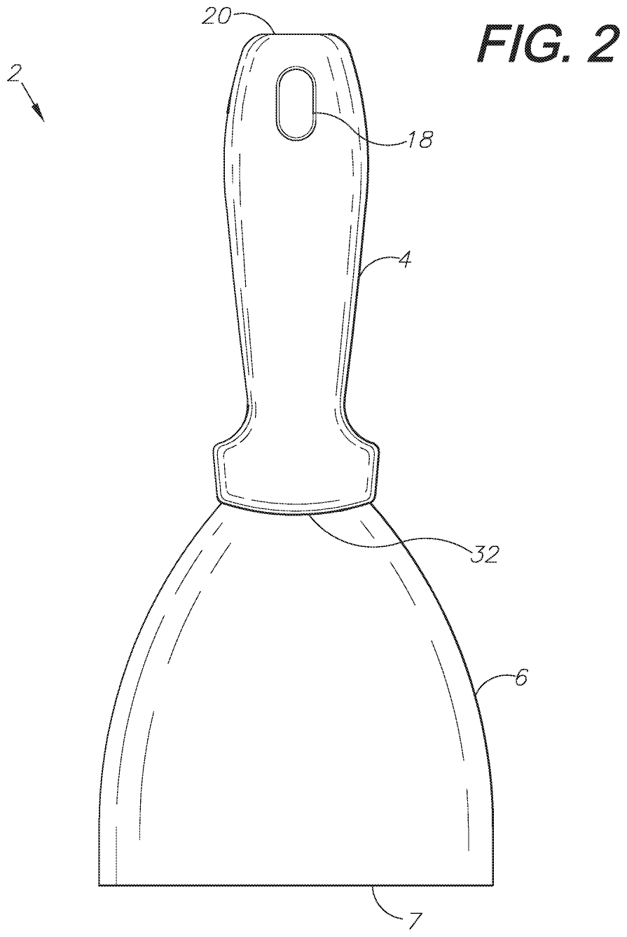

The hand tool 2 of the present application may optionally include a flattened hammer end 20 on the handle 4 proximal end, as shown in FIGS. 2, 5, and 11, to allow a user to hammer nails or other objects with the hand tool 2. The hammer end 20 may or may not be weighted to accommodate more effective hammering.

In an exemplary method of construction of the hand tool 2, as illustrated by FIGS. 6-10, an additional stainless steel tang guide piece 22 having a tang opening or receiver 23 is first welded to the inside of one of the two handle half pieces 8. In a preferred embodiment, this is conducted by first spot welding a rivet or alternative small, extended metal shaft to the handle half 8 which is to receive the additional metal tang guide piece 22. Then, the tang guide piece 22 is placed at a longitudinal position closer to the proximal end of the handle 4 than the distal end, but distal of the hang hole opening 14, and shielded metal arc welded, or stick welded, to the rivet or alternative extended metal shaft. However, alternative welding techniques can be utilized to attach the tang guide piece 22 to the handle half 8.

The second handle half piece 8 is then aligned with the first handle half piece 8, and the handle halves are spot welded together at a total of four points, one point on each side of the distal end of the handle 4 and one point on each side of the proximal end of the handle 4. Next, the handle halves 8 are precision welded to each other around the edges of the handle 4, leaving open the handle distal end tang opening 30. The blade piece elongated tang 12 is then inserted into the handle 4 through the open distal end 30 and through the opening 23 in the additional stainless steel tang guide piece 22 until the hang hole opening 16 of the blade piece tang 12 matches up with the hang hole openings 14 in the handle 4.

A stainless steel hang hole 18 is then inserted through the openings 14, 16 in the handle 4 and the blade piece 6. The hang hole 18 is precision welded to the handle 4 around each handle hang hole opening 14, and the handle 4 is precision welded to the blade piece 6 along the distal end of the handle 4 on either side of the blade piece 6. In a preferred embodiment, the handle 4 includes a curved distal end 32 to provide added surface area for the welded connection of the handle 4 to the blade piece 6 and better displacement of force applied to the blade 7, resulting in added strength and durability of the hand tool 2. However, alternative embodiments include a handle with a straight distal end.

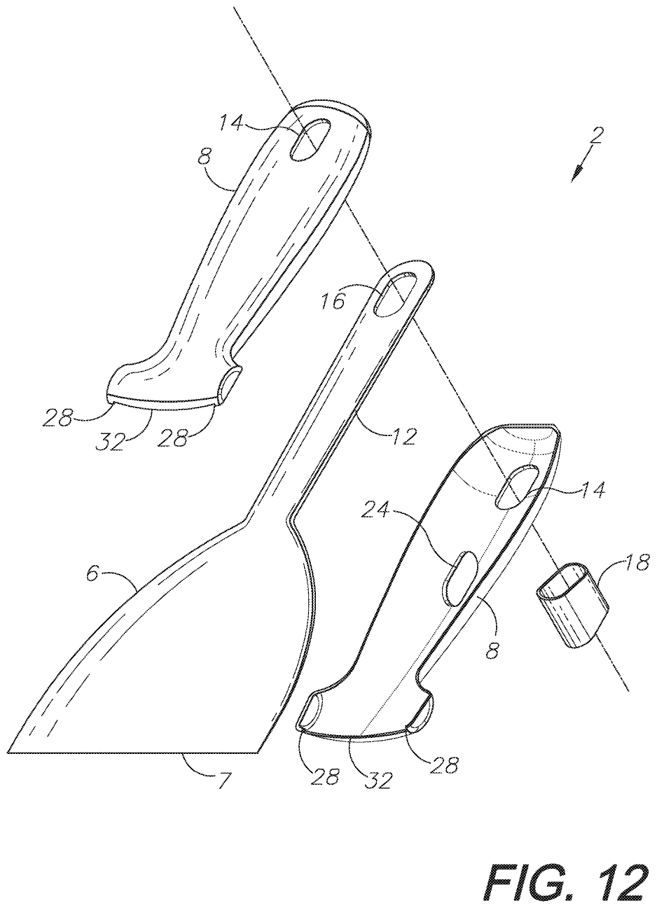

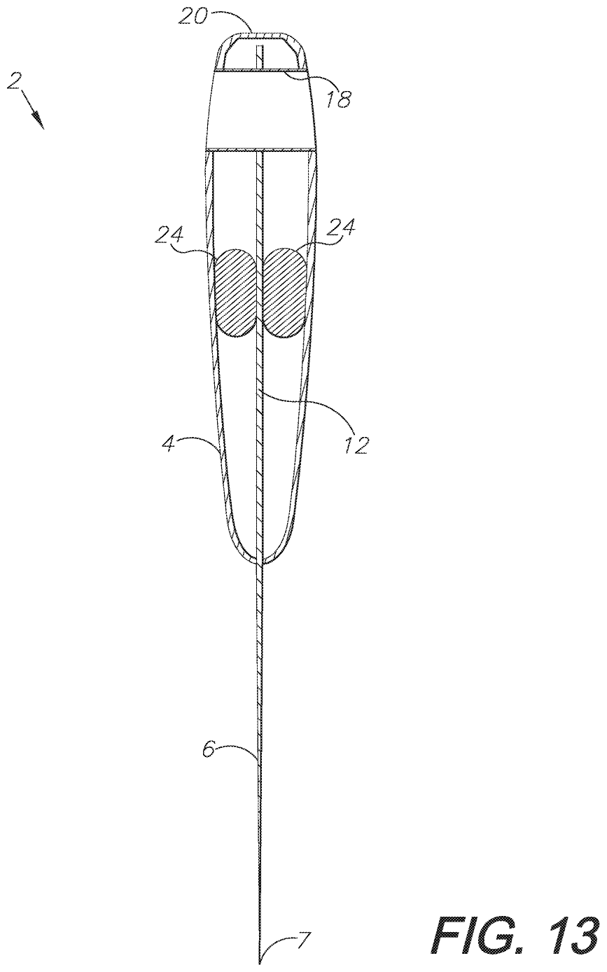

FIGS. 12-13 show the hand tool 2 of the present application having an alternative additional stainless steel tang guide mechanism instead of the tang guide piece 22 shown in FIGS. 6-7, 9, and 11. In this embodiment, each handle half 8 includes an alternative additional stainless steel tang guide piece 24 welded to the inside of the handle half 8 at an approximate midpoint of the handle 4. These alternative tang guide pieces 24 are configured to make contact with the blade piece elongated tang 12 on either side of the tang 12 when the hand tool 2 is assembled, providing an additional point of strength. In construction of the hand tool 2 shown in FIGS. 12-13, the alternative tang guide pieces 24 are welded to the interior of each handle half 8 prior to welding the handle halves 8 together and prior to insertion of the blade piece 6 and the hang hole 18. In further embodiments, each handle half 8 may include multiple additional stainless steel tang guide pieces 24 welded to the interior of the handle 4 to provide additional points of strength. Other embodiments do not include any additional stainless steel tang guide pieces.

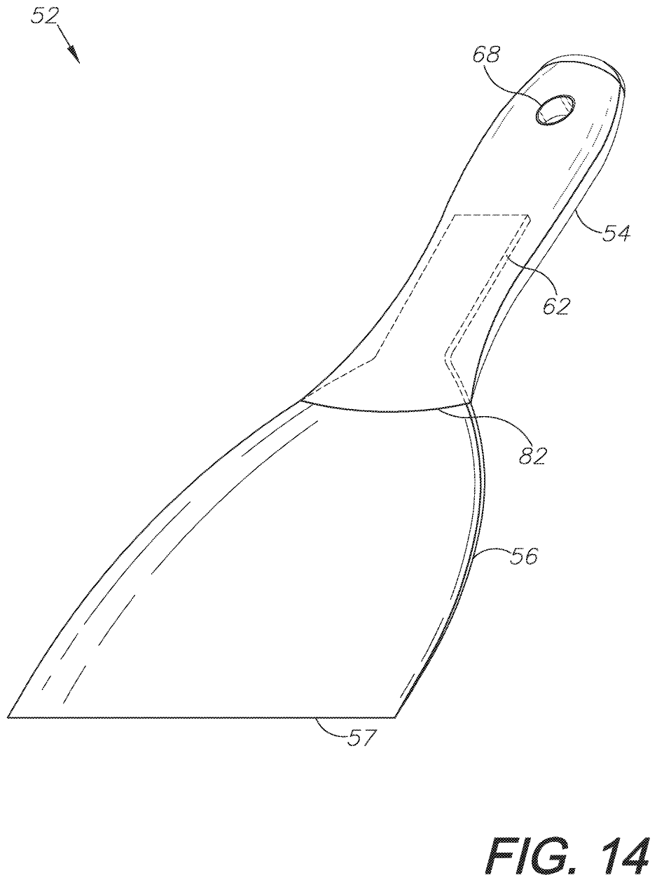

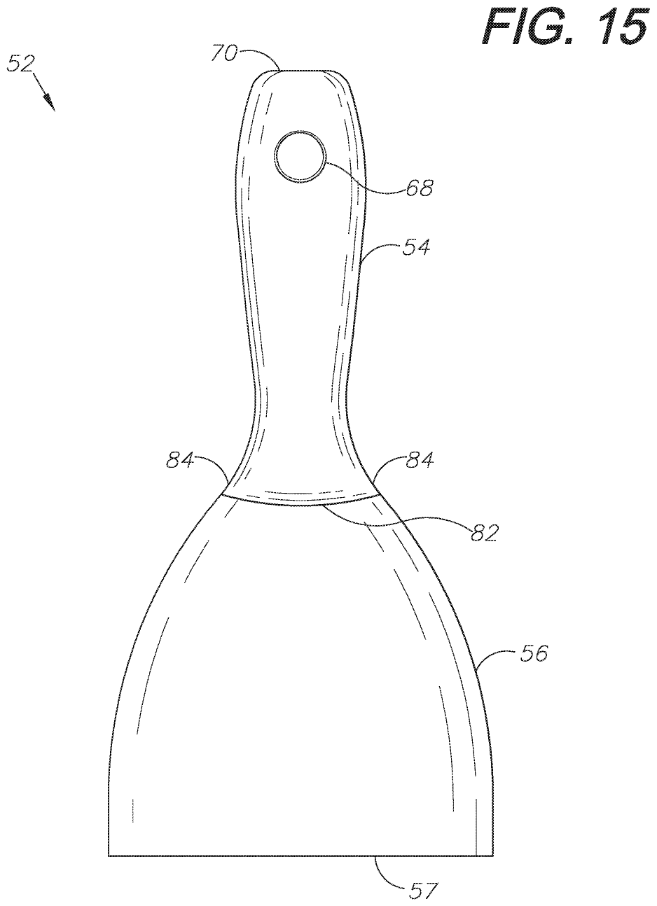

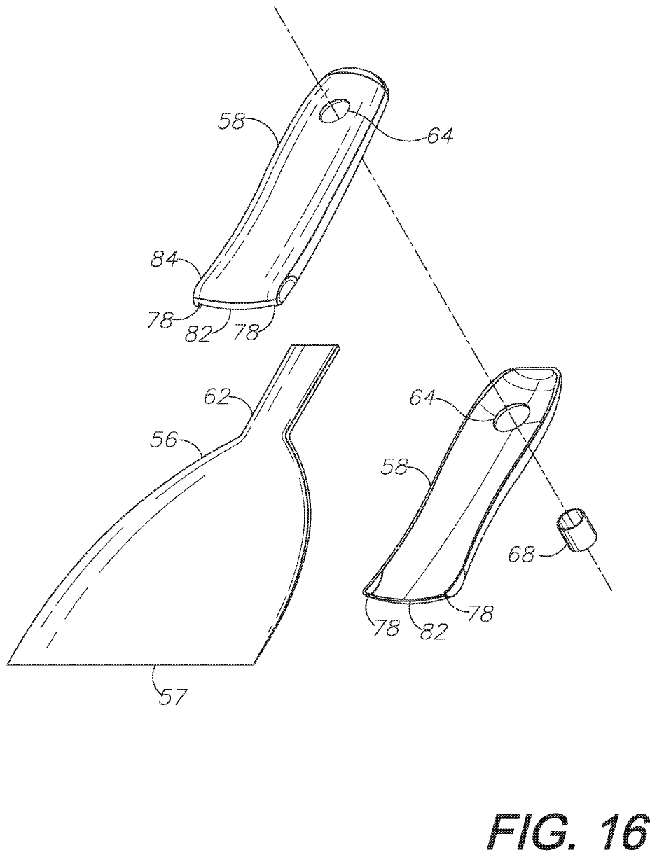

FIGS. 14-16 show an alternative hand tool 52. This alternative embodiment of a hand tool 52 of the present application includes a handle 54 made up of two, symmetrical, contoured handle half pieces 58; a blade piece 56 having a blade 57 opposite an elongated tang 62; and a hang hole piece 68. The handle halves 58 each include an opening 64 for receiving and closely fitting around the hang hole piece 68 and a slight notch 78 at the handle half 58 distal end for forming an opening for receiving and closely fitting around the blade piece elongated tang 62 when the handle 54 is assembled. The handle 54, in this embodiment, further includes a curved distal end 82 and a hammer end 70.

In this embodiment, the blade piece elongated tang 62 extends proximally into the handle 54 but to a position distal of the handle hang hole openings 64. The embodiment shown in FIGS. 14-16 has the elongated tang 62 extending proximally into the handle 54 approximately half the length of the handle 54, however the tang 62 can be configured to extend into the handle 54 to any longitudinal position distal of the hang hole 68. Optionally, the handle 54 can include one or more additional stainless steel tang guide pieces.

The curved handle distal end 82 in this embodiment provides for a strong and durable welded connection between the blade piece 56 and the handle 54. Furthermore, the embodiment shown in FIGS. 14-16 includes a handle 54 with a flared distal end 84 and correspondingly widened blade piece. These handle distal end flares 84 provide additional surface area for the welded connection between the blade piece 56 and the handle 54. The combination of the handle distal end curvature 82 and flared ends 84 provides for a strong and durable welded connection between the blade piece 56 and the handle 54 and efficient displacement of force applied to the blade 57.

In construction of this embodiment, the handle halves 58 are aligned and welded together, first spot welded in four spots and then precision welded around the handle half 58 edges, leaving the distal end open. The blade piece 56 is inserted into the handle 54, and the blade piece 56 is precision welded to the handle 54 along the handle curved distal end 82 on either side of the blade piece 56. The hang hole 68 is inserted through the hang hole openings 64 in the handle halves 58 and then precision welded to the handle 54.

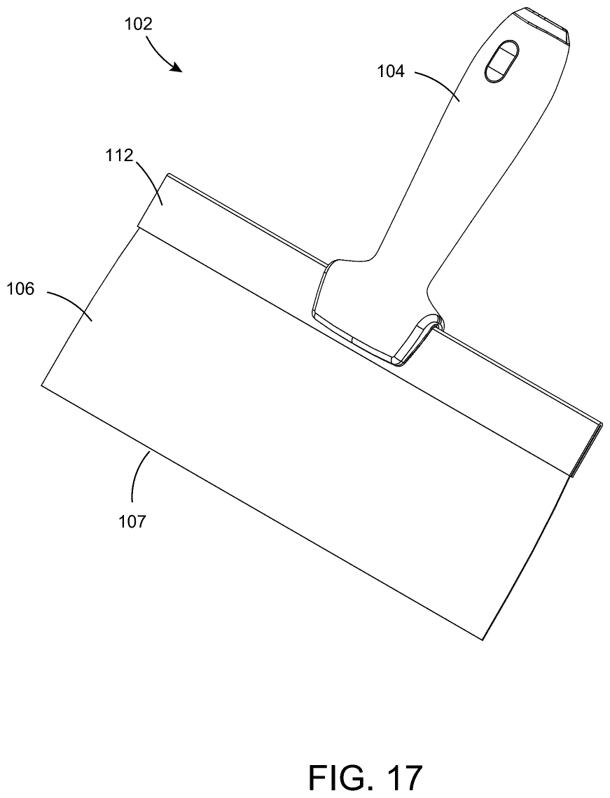

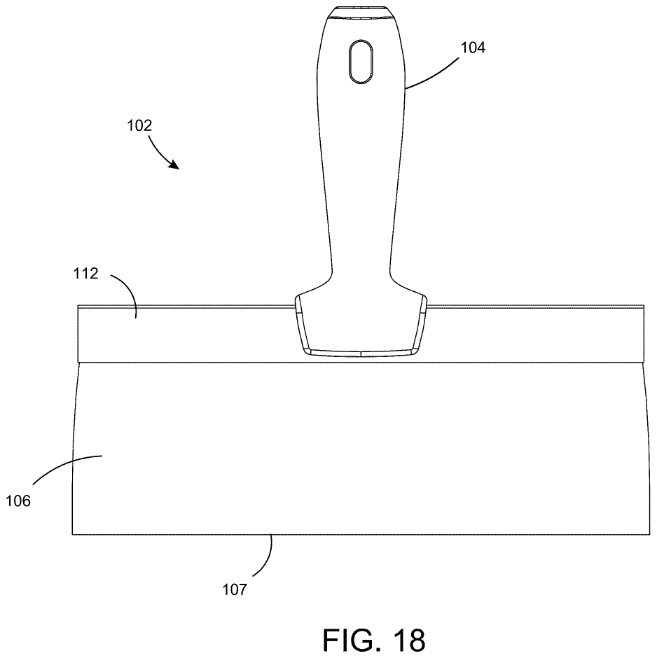

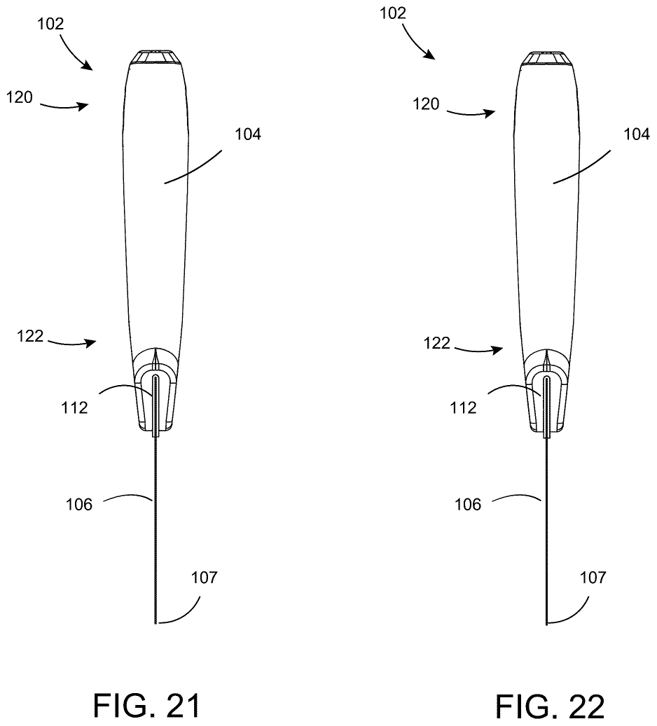

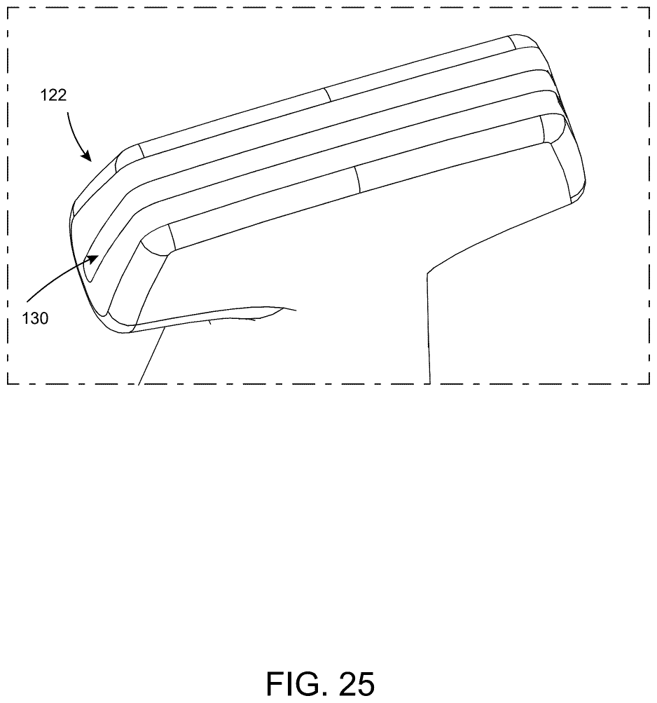

FIGS. 17-25 shows a second alternative hand tool 102. The hand tool 102 may be a taping knife. The hand tool 102 has a blade piece 106 which includes a blade 107 configured for use in making contact with material to be scraped, spread, cut, or flipped. The blade piece 106 has a mounting end 110 which is positioned opposite of the blade 107 and attaches to a backer plate 112. The backer plate 112 attaches to a handle 104. The handle 104 is configured to be held by a user while the user applies force with the blade 107. The blade 107 may be flexible, in addition to being strong and durable, to accommodate efficient spreading, scraping, and/or flipping techniques. The shape, width, and thickness of the blade piece 106 can be varied in different embodiments of the present application. In some embodiments, the distal end of the blade 107 may be sharpened for cutting uses, while in other embodiments, the distal end of the blade 107 may be dull to prevent injury to the user or damage to other objects while still being effective for spreading, scraping, and/or flipping uses.

The blade piece 106 is substantially flat and may be generally rectangular. In some embodiments, the blade piece 106 may taper outward such that a length of the blade 107 is longer than the mounting end 110 of the blade piece 106 that attaches to the backer plate 112. The blade piece 106 and blade 107 can vary in length and can be wider than hand tools 2 and 52. For instance, in some implementations, the blade 107 can vary in length between six inches and sixteen inches. It will be appreciated that the length of the blade can be determined with sound engineering judgement based on the use of the hand tool 102. The backer plate 112 is attached to the blade piece 106 at the mounting end 110. The backer plate 112 provides rigidity to the blade piece 106. As illustrated, the backer plate 112 can be generally U-shaped with a channel configured to receive and encompass the mounting end 110 of the blade piece 106. Alternatively, the backer plate 112 can be two separate plates attached to either side of the mounting end 110 of the blade piece 106. The backer plate 112 can be attached to the blade piece 106 by welding or mechanical fastener like a screw, bolt, rivet, or some other suitable mechanical fastener. For instance, in an implementation, the backer plate 112 can be attached to the blade piece with at least one spot weld. The blade piece 106 and the backer plate 112 may be stainless steel.

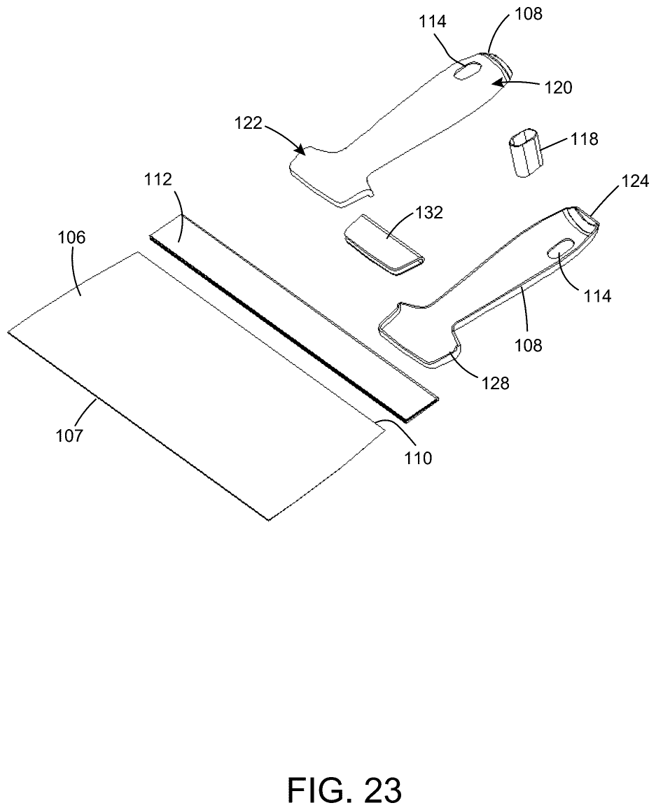

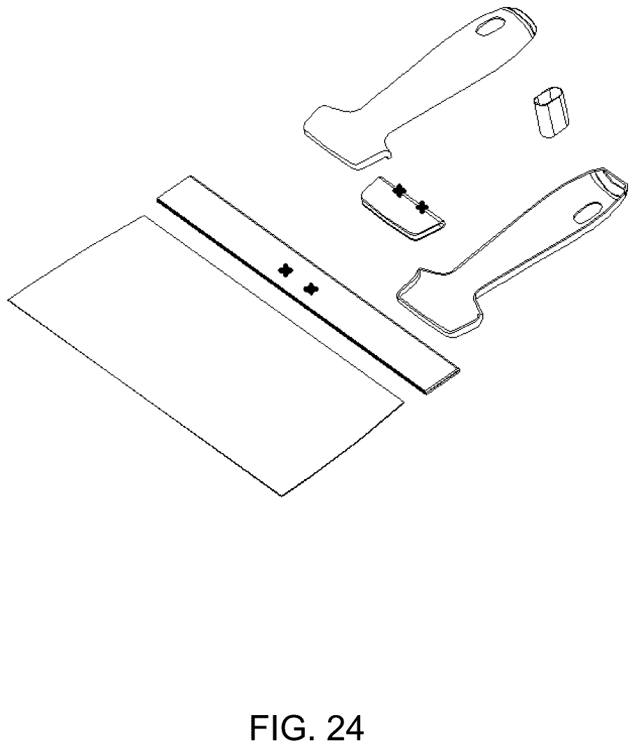

The handle 104 has a proximal end 120 and a distal end 122 opposite the proximal end 124. The handle 104 is attached to the blade portion 106 at the distal end 122. The handle 104 is composed of two symmetrical, contoured handle halves 108, which may be made of a suitable material, such as metal, such as stainless steel. Each handle half 108 has an opening 114 near the proximal end 120 configured for receiving a hang hole piece 118. When assembled, the contour of the handle 104 provides a comfortable, ergonomic fit for a user's hand. In an exemplary embodiment, as shown in FIGS. 23 and 24, the handle halves 108 each have a hollow interior. However, in alternative embodiments, the handle 104 can be made of solid metal, with a recessed groove or channel for connection to the blade piece 106 and an opening 114 for receiving a hang hole piece 118.

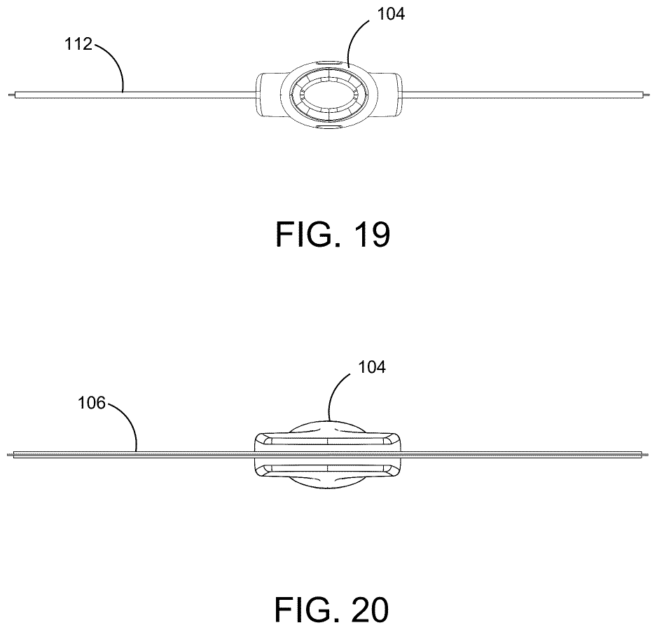

The handle 104 may include a channel 130 in the distal end 122 that is configured to receive the blade portion 106. The channel 130 can be formed in the handle 104 by removing material at the distal end 122 once two handle halves 108 are joined together. For instance, the channel 130 may be cut in the distal end 122 of the handle 104. Alternatively, each handle half piece 108 may include a notch 128 at its distal end 122 such that when the handle halves 108 are aligned and welded together to form the assembled handle 104, the channel 130 is formed at the distal end 122 of the handle 104. The channel 130 may be configured to receive an insert clamp 132, as shown in FIGS. 19-21. The insert clamp 132 may be a folded piece of metal, for instance stainless steel, which has substantially the same shape and profile as the channel 130. It will be appreciated that once folder, the insert claim 132 may have a substantially U-shaped profile. Once inserted into the channel 130, the insert clamp 130 can be welded to the distal end 122 of the handle 104 within the channel 130. Therefore, the distal end 122 of the handle 104 and the channel 130 can be completely sealed from the external environment. The insert clamp 132 can be configured to receive and attach to the backer plate 112. For instance, the insert clamp 132 can be welded to the backer plate 112, for instance with at least one spot weld. It will be appreciated that the blade piece 106 can be attached to the handle 104 by the attachment of the insert clamp 132 to the channel 130 and the subsequent attachment of the insert clamp 132 to the backer plate 112. Alternatively, it will be appreciated that the blade piece 106 can be attached to the handle 104 by the attachment of the insert clamp 132 to the backer plate 112 and the subsequent attachment of the insert clamp 132 to the channel 130 of the handle 104. Alternatively, the channel 130 may be configured to directly receive the backer plate 112. To attach the blade piece 106 to the handle 104, once the backer plate 112 is attached to the blade portion 106, the backer plate 112 or the insert clamp 132 can be welded to the handle along the edge of the channel 130.

As described with the previous embodiments, the edge of the distal end 122 of the handle 104 can be substantially straight or curved. When the distal end 122 has a curved edge, the curved weld provides added strength and durability to the hand tool 102. The curvature provides for additional surface area for the welded connection between distal end 122 of the handle 104 and either the backer plate 112 or the insert clamp 132. Moreover, the curved weld helps to better displace the force applied to the blade 107 when compared to a connection made in one linear plane.

Similar to previous embodiments, the hang hole piece 118 may be made of stainless steel and closely fits through the hang hole opening 114 in each handle half 108. The hang hole piece 118 is welded to the handle 104 around each handle half hang hole opening 114. The hang hole piece 118 of the hand tool 102 allows a user to hang the hand tool 102 on a hook or other object as desired. In the embodiment shown in FIGS. 17, 18, and 23, the sides of the hang hole 18 form an obround or stadium-shape. However, alternatively, the hang hole can be circular, oval-shaped, diamond-shaped, square, rectangular, triangular, or any other shape. Further embodiments may not include a hang hole. Further, similar to hand tool 2, the hand tool 102 of the present application may optionally include a flattened hammer end at the proximal end 122 of the handle 104 to allow a user to hammer nails or other objects with the hand tool 102. The hammer end may or may not be weighted to accommodate more effective hammering.

An exemplary method of construction of the hand tool 102 will be described. First, as previously described, the handle halves 108 and hang hole piece 118 (if included) can be aligned and welded together to form the hollow handle 104 having the channel 130. In this alternative embodiment, it will be appreciated that because the blade does not include a tang like the previous embodiments, the previously described tang guide pieces may not be included in the assembly of the handle 104. However, the tang guide pieces or internal ribs can be included in the handle to strengthen the handle. Once assembled the handle 104 can be cut transversally to form a handle cut opening 140, such that the proximal end 120 and the distal end 122 of the handle 104 are separated from each other to create access to the channel 130 from the hollow the interior of the handle 104.

To assemble the blade, the backer plate 112 can be welded to the blade piece 106. For instance, the backer plate 112 is spot welded to the blade piece 106 in at least one location that can be later covered by portions of the handle 104. The insert clamp 132 can be placed in the channel 130 of the distal end 122 of the handle 104. Next, the backer plate 112 can be inserted into the channel of the insert clamp 132 and be welded to secure the insert clamp 132 to the backer plate. For instance, the insert clamp 132 can be spot welded to the backer plate 112 in at least one spot. As described, it will be appreciated that the backer plate 112 can be welded to the insert clamp 132 through the handle cut opening 140. Alternatively, the backer plate 112 and the insert clamp 132 can be welded before the insert clamp 132 is inserted into the channel 130 of the handle 104. To secure the blade assembly to the handle 104, the insert clamp 132 can be welded to the distal end 122 of the handle 104 along the entire respective edges of the insert clamp 132 and the distal end 122. In one method, the insert clamp 132 and the distal end 122 of the handle 104 are welded together through the handle cut opening 140 such that any result weld bead is on the interior of handle 104. Once the insert clamp 132 is welded to the distal end 122, the distal end 122 and the proximal end 120 of the handle can be welded back together at the handle cut opening 140 and polished to produce a smooth seamless handle. In an alternative method, if the handle 104 is not cut transversally to form the handle cut opening 140 or the handle 104 is solid, the insert clamp 132 and the distal end 122 of the handle 104 may be welded together from the exterior of the handle 104. In alternative methods that do not use an insert clamp 132, the backing plate 112 can be directly welded to the distal end 122 of the handle 104 along the entire edge of the distal end as previously described. Once handle 104 and insert clamp 132 are welded together, the resulting hand tool 102 is a seamless one-piece hand tool that with a handle that has hollow interior that is completely closed off or sealed from the ambient environment. The handle having a seamless one-piece construction prevents liquids, moisture, or other materials like dry-wall compound from accessing the hollow interior of the handle. As such, the closed-off assembly of the handle 104 mitigates the risk of potential rusting or corrosion of the interior of tool. Further, the one-piece characteristic of the tool provides smooth surfaces allowing for easier cleaning compared to existing tools that use mechanical fasteners, like rivets, that introduce additional surfaces and grooves where drywall material can become trapped.

When fully assembled, the hand tool 2, 52, 102 of the present application is an all metal hand tool with a strong and durable connection between its handle and blade piece, in addition to exemplary blade flexion for scraping, spreading, cutting, and/or flipping techniques. Hand tools 2, 52, 102 of the present application accommodate use in the building and construction industry as putty knives, taping knives, and scrapers; in the food industry as scrapers, spatulas, and cutters; and in many other industries.

It is to be understood that while certain embodiments and/or aspects have been shown and described, the application is not limited thereto and encompasses various other embodiments and aspects.

What is claimed is:

1. A metal hand tool comprising:
a blade piece having proximal end and a distal end opposite the proximal end, the blade piece distal end comprising a blade;
a backer plate configured to attach to and encompass the proximal end of the blade; and
a handle having a proximal end and a distal end opposite the proximal end and a hollow interior, the handle having a channel in the distal end, the channel being configured to receive the backer plate,
wherein the backer plate is welded to the blade piece at the proximal end and the backer plate is received within and welded to the channel.

2. The metal hand tool of claim 1, the handle being formed from a pair of welded together, symmetrical handle half pieces.

3. The metal hand tool of claim 1, further comprising an insert clamp configured to receive and attach to the backer plate, wherein the channel is further configured to receive the insert clamp.

4. The metal hand tool of claim 3, wherein the insert clamp is welded to the handle along the entire edge of the channel and welded to the backer plate.

5. The metal hand tool of claim 4, wherein a shape of the insert clamp is substantially the same as a profile of the edge of the channel.

6. The metal hand tool of claim 1, the handle further comprising an opening extending through the proximal end of the handle.

7. The metal hand tool of claim 6, further comprising an open hang hole piece extending through the opening at the proximal end of the handle, the open hang hole piece welded to said handle around outer edges of said hang hole piece.

8. The metal hand tool of claim 1, wherein the hand tool is completely made of stainless steel.

9. The metal hand tool of claim 1, the proximal end of the handle comprising a flattened hammer end.

10. The metal hand tool of claim 1, wherein the blade piece is flexible for accommodating spreading, scraping, or flipping materials, the blade piece configured to flex under an applied pressure.

11. The metal hand tool of claim 1, the distal end of the handle being curved such that the edge of the channel is curved and the resulting welded connection between the channel and the backer plate is curved.

12. The metal hand tool of claim 11, the distal end of the handle being curved concavely away from the proximal end of the handle.

13. The metal hand tool of claim 11, the distal end of the handle being curved convexly toward the proximal end of the handle.

14. A metal hand tool comprising:
a blade piece having proximal end and a distal end opposite the proximal end, the blade piece distal end comprising a blade;
a backer plate configured to attach to and encompass the proximal end of the blade;
an insert clamp configured to receive and attach to the backer plate; and
a handle having a proximal end and a distal end opposite the proximal end and a hollow interior, the handle having a channel in the distal end, the channel being configured to receive the insert clamp,
wherein the backer plate is welded to the blade piece at the proximal end, the backer plate is welded to the insert clamp, and the insert clamp is welded to the handle along an entire edge of the channel.

15. The metal hand tool of claim 14, the handle being formed from a pair of welded together, symmetrical handle half pieces.

16. The metal hand tool of claim 14, wherein a shape of the insert clamp is substantially the same as a profile of the edge of the channel.

17. The metal hand tool of claim 14, wherein the hand tool is completely made of stainless steel.

18. The metal hand tool of claim 14, the distal end of the handle being curved such that the edge of the channel is curved and the resulting welded connection between the channel and the insert clamp is curved.

19. The metal hand tool of claim 14, wherein the interior hollow interior of the handle is sealed from an exterior of the handle.

20. A metal hand tool comprising:
a blade piece having proximal end and a distal end opposite the proximal end, the blade piece distal end comprising a blade;
a backer plate configured to attach to and encompass the proximal end of the blade;
an insert clamp configured to receive and attach to the backer plate;
a handle having a proximal end and a distal end opposite the proximal end and a hollow interior, the handle having a channel in the distal end and an opening extending through the proximal end of the handle, the channel being configured to receive the insert clamp; and
an open hang hole piece extending through the opening at the proximal end of the handle,
wherein the backer plate is welded to the blade piece at the proximal end, the backer plate is welded to the insert clamp, the insert clamp is welded to the handle along an entire edge of the channel the open hang hole piece welded to said handle around outer edges of said hang hole piece and wherein the interior hollow interior of the handle is sealed from an exterior of the handle.
